(19) United States
(12) Patent Application Publication
(10) Pub. No.: US 2026/0260791 A1
(43) Pub. Date: Sep. 3, 2026

(54) CABLE FEEDTHROUGH

(71) Applicant: VEGA GRIESHABER KG, Wolfach (DE)

(72) Inventors: Thomas KOPP, Wolfach (DE); Daniel REINER, Schramberg (DE)

(73) Assignee: VEGA GRIESHABER KG, Wolfach (DE)

(21) Appl. No.: 19/489,993

(22) PCT Filed: Jun. 12, 2024
(86) PCT No.: PCT/EP2024/066222

§ 371 Date: Dec. 4, 2025

(30) Foreign Application Priority Data
Jun. 19, 2023 (DE) 10 2023 205 726.3

(51) Int. Cl. H01B 17/30; G01L 19/14

(52) U.S. Cl. CPC H01B 17/301; G01L 19/145

(57) ABSTRACT

A cable feedthrough is provided, including: a housing with a wall and with an opening configured to feed a cable through; a molded seal inside the housing in an area in front of the opening to provide pressure-tight feedthrough of the cable; a spring element configured to exert a spring force on the molded seal to press the molded seal toward the opening; and a serrated ring pressed against the spring element to preload the spring element, the cable feedthrough being configured to feed the cable through the wall of the housing in a pressure-tight manner.

### REFERENCE TO RELATED APPLICATIONS

The present application claims the priority of German patent application No. 10 2023 205 726.3, filed on Jun. 19, 2023, which is incorporated in its entirety by reference into the present document.

### TECHNICAL FIELD

The present disclosure relates to a cable feedthrough that is configured to pass a cable through the wall of a sensor housing of a measuring probe in a pressure-tight manner. Furthermore, the present disclosure relates to a measuring probe for process automation in industrial or private environments, which has such a cable feed-through, as well as the use of such a cable feedthrough for a measuring probe, in particular for a pressure measuring probe.

### BACKGROUND

In the field of process automation in industrial or private environments, measuring probes are used, for example pressure measuring probes, which are inserted into a container via a cable. The cable serves to connect the measuring probes electrically and to secure them mechanically. Cables that have a metallic shielding surrounded by plastic on the outside, for example, are particularly suitable for this purpose. Supply and/or signal lines can then lead to the probe inside the shielding, protected from external influences.

The cable leads from the probe out of the container to a higher-level unit, e.g., a power supply and/or further electronics.

One application is level measurement using a pressure measuring probe. The pressure measuring probe is inserted into a container filled with a filling material via the cable. The pressure determined by the pressure measuring probe corresponds to the height of the filling material column above the pressure measuring probe and is therefore a measure of the level in the container.

In these applications, a cable feedthrough may be required for sealing downstream electronics and/or a higher-level unit, which has a housing through which the cable is fed. The housing may be part of the higher-level unit and/or part of a mounting device for the probe, for example, by mounting the housing at the measuring location, e.g., on a container, using a flange or a thread.

Similarly, the cable feedthrough may be located on the probe and connected, for example, to the probe or a probe housing (hereinafter also referred to as sensor housing) to ensure that no filling material enters the probe.

### SUMMARY

There may be a desire to provide a cable feedthrough for the pressure-tight passage of a cable through a wall of a sensor housing of a measuring probe, which has a simple design and good sealing effect.

This desire is met by the features of the independent patent claims. Further developments are set out in the dependent claims.

A first aspect of the present disclosure relates to a cable feedthrough which is designed for the pressure-tight passage of a cable through a wall of a sensor housing of a measuring probe. The cable feedthrough has a housing with an opening which is designed for the passage of the cable into the interior of the housing.

The housing of the cable feedthrough and the sensor housing may be the same housing and, in particular, may be designed as a single piece. However, it is also possible for the sensor housing to be detachably connected to the housing of the cable feedthrough, for example, they may be screwed together, for example, by means of a screwable plug connection.

The cable feedthrough has a molded seal inside the housing, which is located in the area in front of the opening to provide a pressure-tight passage for the cable. A spring element is provided, which is designed to exert a spring force on the molded seal in order to press the molded seal in the direction of the opening by exerting a compressive force. A serrated ring or the like is provided to preload the spring element, which is pressed against the spring element, i.e., located on the opposite side of the molded seal compared to the housing opening.

According to an embodiment of the present disclosure, the housing tapers in the area of the opening so that the molded gasket can be pressed well.

According to a further embodiment of the present disclosure, the housing is designed as a single piece. An interface to the sensor housing of the measuring probe may be provided at the end opposite the opening, or the measuring probe may be located in the housing of the cable feed-through, for example at this end.

According to a further embodiment of the present disclosure, the housing is tubular, resulting in low manufacturing costs and high stability.

According to a further embodiment of the present disclosure, the serrated ring has a plug-in tongue for contacting the cable.

The term “serrated ring” refers to a retaining means which rests against the inside of the housing wall and is connected to it by friction, so that it can exert the necessary pressure on the spring element. This refers to mechanical means which fulfill this function, for example a serrated ring. However, other solutions are also possible which enable this retaining means to be wedged/clamped to the inside wall of the housing. The serrated ring is only one simple way of providing this function. The term “serrated ring” should therefore be interpreted broadly.

According to a further aspect of the present disclosure, a measuring probe is specified, configured for process automation in an industrial or private environment, which has a sensor unit with a sensor housing, a cable designed to connect the sensor unit to a power supply and/or an evaluation unit located outside the measuring probe, and the cable feedthrough described above and below.

The sensor housing may be integrally connected to the housing of the cable feedthrough, or the sensor unit may be located in the housing of the cable feedthrough.

For example, the measuring probe is a pressure measuring probe.

The term “process automation in an industrial environment” refers to a branch of technology that involves measures for operating machines and systems without human intervention. One goal of process automation is to automate the interaction of individual components of a plant in the chemical, food, pharmaceutical, petroleum, paper, cement, shipping, or mining industries. A wide range of sensors can be used for this purpose, which are specially adapted to the specific requirements of the process industry, such as mechanical stability, insensitivity to contamination, extreme temperatures, and extreme pressures. The measured values from these sensors are usually transmitted to a control room, where process parameters such as fill level, limit level, flow, pressure, or density can be monitored and settings for the entire plant can be changed manually or automatically.

One sub-area of process automation in the industrial environment concerns the logistics automation of plants and the logistics automation of supply chains. With the help of distance and angle sensors, processes within or outside a building or within a single logistics facility are automated in the field of logistics automation. Typical applications include logistics automation systems for baggage and cargo handling at airports, traffic monitoring (toll systems), retail, parcel distribution, and building security (access control). What the examples listed above have in common is that presence detection in combination with accurate measurement of the size and position of an object is required by the respective application. For this purpose, sensors based on optical measurement methods using lasers, LEDs, 2D cameras, or 3D cameras that measure distances using the time-of-flight (ToF) principle can be used.

Another subfield of process automation in the industrial environment concerns factory/production automation. Applications for this can be found in a wide variety of industries, such as automotive manufacturing, food production, the pharmaceutical industry, or in the packaging sector in general. The aim of factory automation is to automate the manufacture of goods using machines, production lines, and/or robots, i.e., to run without human intervention. The sensors used and the specific requirements in terms of measurement accuracy when detecting the position and size of an object are comparable to those in the previous example of logistics automation.

The terms used in the claims should be interpreted in such a way that they are given the broadest possible reasonable interpretation in accordance with the above description. For example, the use of the article “a” or “the” when introducing an element should not be interpreted as excluding a plurality of elements. Similarly, the mention of “or” should be interpreted as including a plurality of elements, so that the mention of “A or B” does not exclude “A and B” unless it is clear from the context or the preceding description that only one of A and B is meant. Furthermore, the phrase “at least one of A, B, and C” should be understood as one or more elements from a group of elements consisting of A, B, and C, and should not be interpreted as requiring at least one of each of the listed elements A, B, and C, regardless of whether A, B, and C are connected as categories or in any other way. In addition, the mention of “A, B, and/or C” or “at least one of A, B, or C” should be interpreted as including each individual unit of the listed elements, e.g., A, each subset of the listed elements, e.g., A and B, or the entire list of elements A, B, and C.

Another aspect of the present disclosure relates to the use of a cable feedthrough described above and below for a measuring probe, in particular for a pressure measuring probe.

Further embodiments of the present disclosure are described below with reference to the figures. Where the same reference numerals are used in the following description of the figures, they denote the same or similar elements. The representations in the figures are schematic and not to scale.

### BRIEF DESCRIPTION OF THE FIGURES

FIG. 1 shows a cable feedthrough with a measuring probe according to an embodiment.

FIG. 2 shows a cross-sectional view of a cable feedthrough according to an embodiment.

FIG. 3 shows a serrated ring according to an embodiment.

### DETAILED DESCRIPTION OF EMBODIMENTS

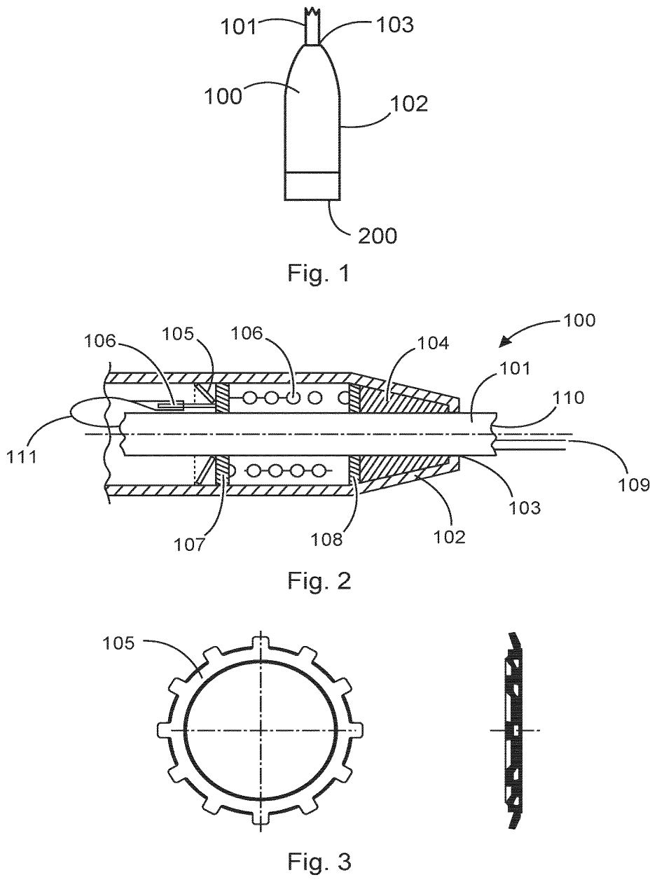

FIG. 1 shows a cable feedthrough 100 with a measuring probe 200 at one end. At the other end, there is an outlet opening through which the cable 101 is fed.

FIG. 2 shows a cross-sectional view of a cable feedthrough 100 designed to allow a cable 101 to pass through the wall of the housing 102 of the cable feedthrough in a pressure-tight manner. The cable 101 has one or more cores 109, a ground connection 110, and a plastic sheath. The ground connection 110 is connected at its end 111 to the plug tongue 106 of the serrated ring 105. The serrated ring 105 wedges itself against the inner wall of the housing 102 so that it cannot slip. In doing so, it presses against the spring element 106. A washer 107 may be located between the spring element 106 and the serrated ring 105. The spring element 106 presses back against the molded seal 104, which is located at the tapered end of the housing 102, and thus presses against the cable 101 to achieve a good sealing effect. A washer 108 may also be arranged between the molded seal 104 and the spring element 106 in order to distribute the pressure evenly across the molded seal 104. The cable 101 exits the cable feedthrough 100 through the opening 103 at the tapered end.

In order to compensate for the sealing effect on the cable 101 or the housing 102, which diminishes due to aging processes, the clamped molded seal 104, which may be made of an elastomer, is pressed in addition to its own restoring force by the spring element 106, for example a compression spring. In order for the compression spring to transmit force, the preload is generated via the serrated ring 105. A multi-part design of the housing 102 via a threaded connection is not necessary. No forming (flanging) is required either. Since the housing does not have to be plastically formed in order to achieve the contact force (and thus a sealing effect), the manufacturing effort is reduced. In addition, a casting may be provided, but is not necessary, to further increase the sealing effect.

The housing 102 can be designed as a one-piece housing tube with the function of a sealing area and a sealing compound area. Assembly is carried out in the figure from the left side of the housing, i.e., the side with the larger opening, by inserting all components toward the smaller opening 103.

The components molded seal 104, spring element 106, and, if applicable, two support washers 107, 108 are inserted or pressed into the tube 102 together with the serrated ring 105. The serrated ring 105 is mounted so that it is first inserted into the pipe with the smaller diameter area. The two washers 107, 108 are not absolutely necessary for the function, but serve to improve or even out the force transmission to the molded gasket 104 when a spiral pressure spring is used.

Once the serrated ring 105 has been inserted into the tube 102 and the serrations are in contact with the inner diameter, the obliquely shaped serrations ensure frictional adhesion to the inner surface of the tube. The serrated ring 105 can now only be moved in the direction of the molded seal 104.

There are several options for mounting with a specific spring preload on the molded seal 104. For example, a punch can be used to compress the spring element 106 to a defined dimension. Alternatively, a force-controlled press can be used to set the desired pressing force.

The serrated ring 105 prevents the molded seal 104 from retreating and relaxing. Depending on the dimensions of the serrated ring 105, a force of 800 newtons can be maintained at a nominal diameter of 20 mm. The special shape of the serrated ring 105, e.g., with a plug-in tongue 106, also allows contact between the cable 101 and the housing 102 for electrical purposes, e.g., for shielding or grounding.

The housing 102 may be designed as a single piece and have a casting area. A multi-piece housing is not necessary and therefore no connection process using threads with seals or welding of the two housing parts is required.

1-8. (canceled)

9. A cable feedthrough, comprising:
a housing with a wall and with an opening configured to feed a cable through;
a molded seal inside the housing in an area in front of the opening to provide pressure-tight feedthrough of the cable;
a spring element configured to exert a spring force on the molded seal to press the molded seal toward the opening; and
a serrated ring pressed against the spring element to preload the spring element, wherein the cable feedthrough is configured to feed the cable through the wall of the housing in a pressure-tight manner.

10. The cable feedthrough according to claim 9, wherein the cable feedthrough is further configured to feed the cable through a sensor housing of a measuring probe in a pressure-tight manner.

11. The cable feedthrough according to claim 9, wherein the housing tapers in the area in front of the opening.

12. The cable feedthrough according to claim 9, wherein the housing is a single piece.

13. The cable feedthrough according to claim 9, wherein the housing is tubular.

14. The cable feedthrough according to claim 9, wherein the serrated ring has a plug-in tongue configured to contact the cable.

15. A measuring probe configured for process automation in industrial or private environments, the measuring probe comprising:
a sensor unit with a sensor housing;
a cable configured to connect the sensor unit to a power supply and/or an evaluation unit; and
the cable feedthrough according to claim 15, the cable feedthrough being further configured to feed the cable through the wall of the sensor housing in a pressure-tight manner.

16. The measuring probe according to claim 15, wherein the measuring probe is a pressure measuring probe.
